(19) United States
(12) Patent Application Publication
(10) Pub. No.: US 2014/0106837 A1
(43) Pub. Date: Apr. 17, 2014

(54) CROWDSOURCING TO IDENTIFY GUARANTEED SOLVABLE SCENARIOS

(71) Applicant: MICROSOFT CORPORATION, Redmond, WA (US)

(72) Inventor: Kevin Lambert, Kirkland, WA (US)

(73) Assignee: Microsoft Corporation, Redmond, WA (US)

(21) Appl. No.: 13/650,469

(22) Filed: Oct. 12, 2012

(51) Int. Cl. G06F 17/30; G06F 19/00

(52) U.S. Cl. 463/11; 707/812; 707/E17.005; 707/E17.032

(57) ABSTRACT

A method is disclosed for using crowdsourcing to identify known-solvable data states which have been identified by users as leading to a solution to a scenario with defined constraints. In one example where the scenario is a computer card game, a number of users may be provided with an initial data state in the form of the cards being in a particular order. Where a user successfully completes the card game to a desired solution state, the initial data state of the cards may be stored as a known-solvable data state.

### BACKGROUND

Gaming systems have evolved from those which provided an isolated gaming experience to networked systems providing a rich, interactive experience which may be shared in real time between friends and other gamers. With Microsoft's Xbox® video game system and Xbox Live® online game service, users can now engage in a wide variety of computerized gaming experiences.

There exist certain games, puzzles, and other interactive scenarios, the structure of which begins with one of a possible number of initial states, possibly randomly generated. From these initial states, events such as player inputs, according to some set of rules, trigger transitions to multiple intermediate states, the sequence of states possibly culminating in a defined desired solution state. In certain scenarios, some initial states do not allow for successful completion to the desired solution state, regardless of player inputs. For example, in the well-known game Klondike Solitaire, it is estimated that merely about 15% of all possible initial states allow a player to reach the desired solution state (all cards, ordered by suit in succession ace to king).

For some such games and puzzles, based on sheer complexity and number of permutations of initial and intermediate states or some other reason, it may be impractical or impossible to determine algorithmically whether or not a given initial state can end in a desired solution state. It may therefore be useful to find alternative means to answer whether, and to what degree, an initial state of a game or puzzle is or is not solvable by some sequence of moves or steps.

### SUMMARY

Embodiments of the present system generally relate to a system for generating an initial state for a game, puzzle, problem or other scenario, crowdsourcing this initial state to participants in the scenario, and collecting data on the solvability of the initial state based on intermediate and end states reached by participants. Embodiments may also compare solved initial states to others in a database of solved data states, and, if the initial state is not found, adding to the database information pertaining to the newly solved initial state. Additionally, embodiments of the system may use data obtained by recording the progress of users in the given scenario to qualitatively or quantitatively determine and inform users how solvable or not the given scenario is for the initial state presented to the users.

An embodiment of the present technology relates to a method for identifying a subset of one or more initial data states which are solvable to reach a desired solution state in a scenario to be solved, the method comprising serving a group of initial data states to a group of users, the group of initial data states including the subset of one or more initial data states which are solvable, determining one or more instances of the scenario being solved to the desired solution state by one or more users, and storing information to identify the subset of one or more initial data states from which the scenario was solved by the one or more users in said determination.

Another embodiment of the present technology relates to a method for identifying known-solvable data states from a larger group of data states, the known-solvable data states being those data states from which users may reach a desired solution state in a scenario having a set of constraints, the method comprising serving initial data states from a server to a group of user consoles for users of the user consoles to solve the scenario from the initial data states, receiving indications of user-interaction with the initial data states, to generate intermediate data states, in attempts by the users to solve the scenario, determining one or more instances of the scenario being solved to the desired solution state by one or more users, and storing information to identify the known-solvable data states from which the scenario was solved by the one or more users in said determination.

A further embodiment of the present technology relates to a computer-readable medium having computer-executable instructions for programming a processor to perform a method of identifying known-solvable initial data states from a larger group of initial data states, the initial data states being an initial order of cards displayed to a user in a computerized card game, and the known-solvable initial data states being initial orderings of cards from which users may successfully complete the card game to a desired solution state, the method comprising generating the initial data states of cards, serving the initial data states from a server to a group of user consoles for users of the user consoles to play the card game from the initial data states, receiving indications of user-interaction with the initial data states, to generate intermediate data states as users play the card game, determining one or more instances where one or more users successfully complete the card game to the desired solution state, and storing information to identify the known-solvable initial data states from which the card game was successfully completed to the desired solution state in said determination.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an isometric view of an exemplary gaming and media system.

FIG. 2 is an exemplary functional block diagram of components of the gaming and media system shown in FIG. 1.

FIG. 3 is a block diagram of an exemplary operating environment for creating, processing, and communicating solvability information.

FIG. 4 is a flow diagram of an exemplary method for producing, sharing and receiving state data, including solvability, with the user.

FIG. 5 is a flow diagram of an exemplary method for producing, sharing and receiving state data, including solvability, with the user, specifically able to record and retain intermediate states.

FIG. 6 is a flow diagram of a method for providing to the user states known to be solvable in order for the user to attempt to solve the scenarios.

FIG. 7 is a flow diagram of an exemplary method for providing to user initial states for scenarios in order to learn whether users can reach states known to be solvable in those scenarios.

FIG. 8 is a flow diagram of a method for providing to the user states known to be solvable for scenarios in order to learn whether users can take alternative paths from those states to solve those scenarios.

### DETAILED DESCRIPTION

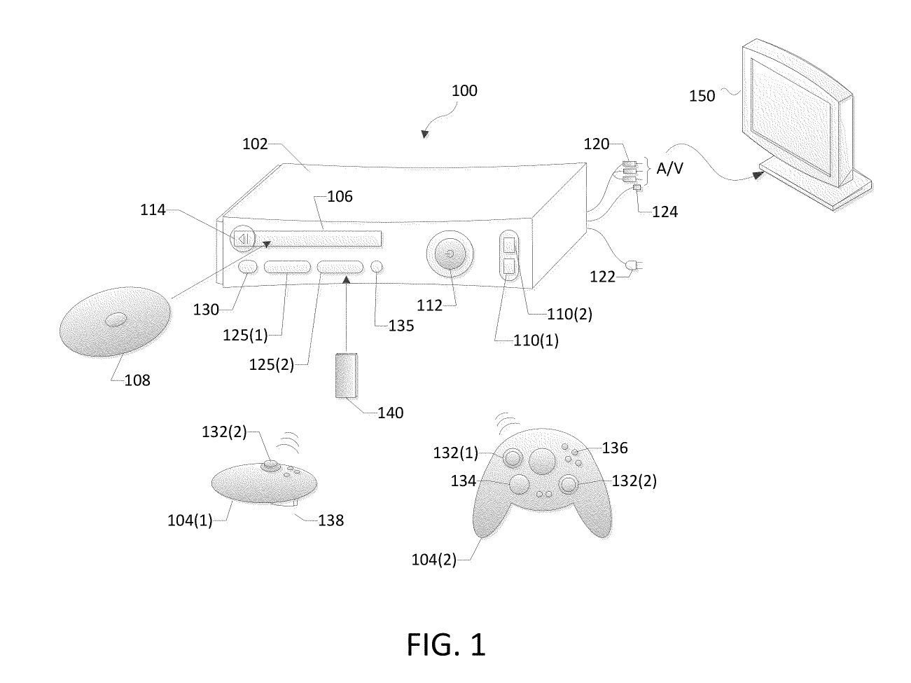

The present technology will now be described with reference to FIGS. 1-8, which in general relate systems and methods using crowdsourcing to accumulate a set of known-solvable data states for a given scenario. Through crowdsourcing, a large number of users can be served a scenario such as a game or puzzle including an initial state of data. The data states for those users that successfully complete the scenario can be identified and accumulated in a database of known-solvable data states. In embodiments, the known-solvable data states that are stored may be the initial data state, but it may be intermediate data states in further embodiments.

As used herein, “crowdsourcing” may refer to providing a scenario to be solved to one or more users to identify data states which result in successful completion of the scenario by one or more users to a desired solution state. “Crowdsourcing” as used herein may also be used to determine other metrics relating to the solution of a scenario. For example, crowdsourcing may be used to determine how many interactions it takes users to reach a desired solution from a given initial or intermediate data state. Crowdsourcing may also be used to identify patterns in how users attempted to solve a given scenario, and points at which users turned an otherwise solvable scenario into one which may not be solved from a given intermediate state of data.

In some embodiments, the present technology can be used in situations where, for given scenarios, distinguishing between initial states that are solvable and those that are not is either impossible or cumbersome for computer algorithms. This difficulty may arise, for instance, because of the inordinate time used by computers to sift through the vast quantity of permutations of initial states, transitions, intermediate states, and terminal states that may be generated by the rules of the given scenario. However, it should be noted that embodiments of the present technology can be used to identify solvable initial and/or intermediate states where doing so is viable by using computational machines or procedures.

Embodiments of the present technology are set forth above and below in generic terms, not to be taken as limiting. In embodiments, one or more users are presented with a scenario to be solved. In embodiments, a plurality of different users is served with one or more initial states of data, from which the goal is to converge to the same solution state while limited to the same set of rules or constraints. In one of many possible examples, the scenario in question may be a computer game, such as Klondike Solitaire. In Klondike Solitaire, the cards are ordered in an initial state, and then arranged in a beginning configuration of cards presented to the player at the start of the game.

In one example, the initial state of a Klondike Solitaire would be a shuffled arrangement of cards in a virtual deck. The virtual cards may be arranged in six piles of downturned cards of increasing (left-to-right) height (by one) from zero, each topped by an upturned card. The intermediate states of the game are transformations of the initial state brought about by player interactions that are deemed valid by the rules of Klondike Solitaire. One such possible interaction may be the filling of an empty pile with a stack of cards containing a king. The desired solution state for Klondike Solitaire may be reached once the player, following the rules of the game, has manipulated the initial and intermediate states to obtain a set of four “foundation” piles of cards, each ordered successively from ace to king, such that cards in a given foundation pile are of the same suit. Embodiments of the present technology are not limited to scenarios of Klondike Solitaire.

In a game of Klondike Solitaire, or other card game starting with a randomly shuffled deck of 52 cards, there are 52!, or 8×10⁶⁸, different permutations of the initial ordering (initial state data) of the cards. Each interaction of the user to move cards around generates intermediate states adding to the number of permutations which need to be computed. As such, identification of initial and/or intermediate state data which can potentially lead to successful completion of a game to the desired solution state may be impractical by computer algorithm. It is understood that the present technology may be used on other versions of Solitaire, or other computer games or puzzles, or games or puzzles of any kind. These other games and puzzles include, without limitation, FreeCell Solitaire (a card game), Spider Solitaire (a card game), Pyramid Solitaire (a card game), TriPeaks Solitaire (a card game), Mahjong Solitaire (a tile-matching game), Minesweeper (a puzzle game), Bridge (a card game), Chess (a game with pieces). In further embodiments, the present technology may be used to identify known-solvable data states in scenarios other than games or puzzles. One such further example is in the sequencing of DNA and other genetic material.

Further embodiments of the present technology may generate arbitrary states of a scenario for users to continue and solve. For example, in the case of scenarios for the game chess, embodiments of the present technology may provide to users (as states) board configurations of chess pieces reachable from the initial configuration by some pattern of one or more legal moves possible between players over the course of the game. References to chess or any other particular scenario made prior or hereafter are merely cited as exemplary, not intended to limit the scope of possible embodiments of the present technology.

Possible embodiments of the present technology may present initial states of a given scenario to users, record the users' progress, including data uniquely identifying intermediate states obtained in the course of attempted solution, in the given scenario, and update a database with data representing the users' progress. In the case of initial states for a given scenario which users solve, embodiments of the present technology may use the intermediate data states to generate data pertaining to the solvability of the initial state for the given scenario. For example, if users complete a game of chess to checkmate from a provided initial state in N moves, embodiments of the present technology may record data indicating that the provided initial state is solvable within N moves. Alternatively, if users complete a game of chess to checkmate from a provided initial state over the course of N hours, embodiments of the present technology may record data indicating that the provided initial state is solvable within N hours. Embodiments of the present technology may store this solvability data and/or make it available to users.

Alternative embodiments of the present technology may provide initial states of a given scenario to users, and record initial and intermediate data states resulting from users' progress, and update a database with data representing users' progress. If a user solves the scenario to a desired solution state, both the initial data states and the intermediate data states can be stored in a solutions database. These intermediate data states can be used for example to provide later users a guarantee that a solution state may be reached from given stored intermediate state. It is further contemplated that initial and/or intermediate data states which did not lead to successful completion of a scenario to a desired solution state may provide useful information to users. For example, where later users are served an initial data state, the users can be notified that no one has solved the scenario from the given initial data state.

FIG. 1 shows an exemplary gaming and media system 100. The following discussion of FIG. 1 is intended to provide a brief, general description of a suitable environment in which concepts presented herein may be implemented. It is understood that the system of FIG. 1 is by way of example only. In further examples, the present system may be implemented on a variety of client computing systems, either via a browser application or a software application resident on and executed by the client computing system. As shown in FIG. 1, gaming and media system 100 includes a game and media console (hereinafter “console”) 102. In general, console 102 is one type of client computing system, as will be further described below. Console 102 is configured to accommodate one or more wireless controllers, as represented by controllers 104(1) and 104(2). Console 102 is equipped with an internal hard disk drive (not shown) and a portable media drive 106 that support various forms of portable storage media, as represented by optical storage disc 108. Examples of suitable portable storage media include DVD, CD-ROM, game discs, and so forth. Console 102 also includes two memory unit card receptacles 125(1) and 125(2), for receiving removable flash-type memory units 140. A command button 135 on console 102 enables and disables wireless peripheral support.

As depicted in FIG. 1, console 102 also includes an optical port 130 for communicating wirelessly with one or more devices and two USB (Universal Serial Bus) ports 110(1) and 110(2) to support a wired connection for additional controllers, or other peripherals. In some implementations, the number and arrangement of additional ports may be modified. A power button 112 and an eject button 114 are also positioned on the front face of game console 102. Power button 112 is selected to apply power to the game console, and can also provide access to other features and controls, and eject button 114 alternately opens and closes the tray of a portable media drive 106 to enable insertion and extraction of a storage disc 108.

Console 102 connects to a television or other display (such as monitor 150) via A/V interfacing cables 120. In one implementation, console 102 is equipped with a dedicated A/V port (not shown) configured for content-secured digital communication using A/V cables 120 (e.g., A/V cables suitable for coupling to a High Definition Multimedia Interface “HDMI” port on a high definition monitor 150 or other display device). A power cable 122 provides power to the game console. Console 102 may be further configured with broadband capabilities, as represented by a cable or modem connector 124 to facilitate access to a network, such as the Internet. The broadband capabilities can also be provided wirelessly, through a broadband network such as a wireless fidelity (Wi-Fi) network.

Each controller 104 is coupled to console 102 via a wired or wireless interface. In the illustrated implementation, the controllers 104 are USB-compatible and are coupled to console 102 via a wireless or USB port 110. Console 102 may be equipped with any of a wide variety of user interaction mechanisms. In an example illustrated in FIG. 1, each controller 104 is equipped with two thumbsticks 132(1) and 132(2), a D-pad 134, buttons 136, and two triggers 138. These controllers are merely representative, and other known gaming controllers may be substituted for, or added to, those shown in FIG. 1.

In one implementation, a memory unit (MU) 140 may also be inserted into controller 104 to provide additional and portable storage. Portable MUs enable users to store game parameters for use when playing on other consoles. In this implementation, each controller is configured to accommodate two MUs 140, although more or less than two MUs may also be employed.

Gaming and media system 100 is generally configured for playing games stored on a memory medium, as well as for downloading and playing games, and reproducing pre-recorded music and videos, from both electronic and hard media sources. With the different storage offerings, titles can be played from the hard disk drive, from an optical disk media (e.g., 108), from an online source, or from MU 140. Samples of the types of media that gaming and media system 100 is capable of playing include:
Game titles played from CD and DVD discs, from the hard disk drive, or from an online source.
Digital music played from a CD in portable media drive 106, from a file on the hard disk drive (e.g., music in the Windows Media Audio (WMA) format), or from online streaming sources.
Digital audio/video played from a DVD disc in portable media drive 106, from a file on the hard disk drive (e.g., Active Streaming Format), or from online streaming sources.

During operation, console 102 is configured to receive input from controllers 104 and display information on display 150. For example, console 102 can display a user interface on display 150 to allow a user to select a game using controller 104 and display state solvability information as discussed below.

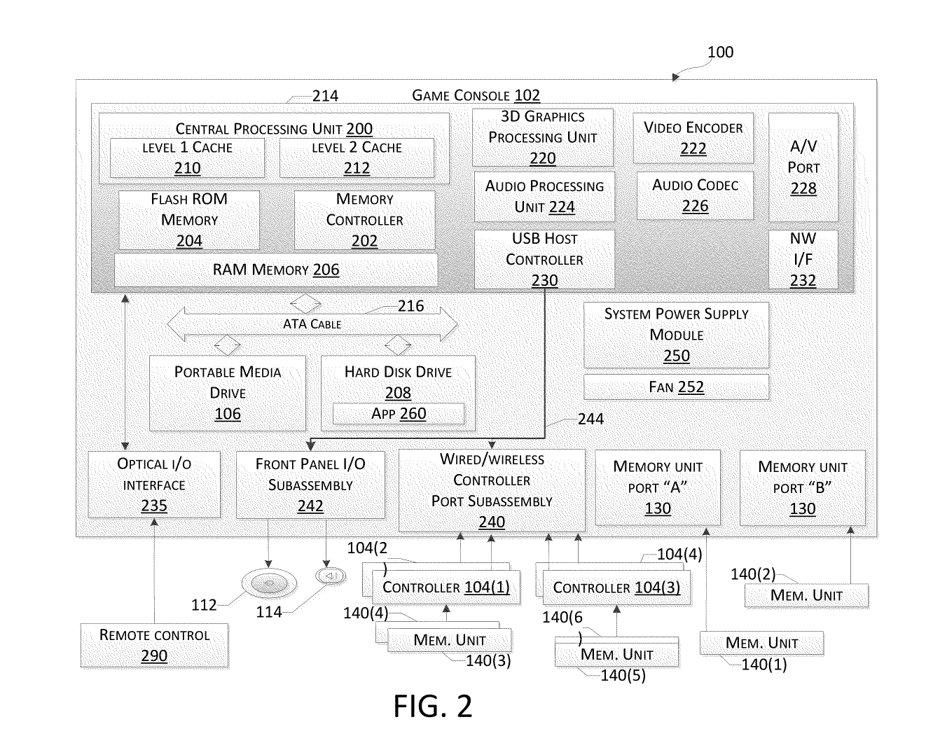

FIG. 2 is a functional block diagram of gaming and media system 100 and shows functional components of gaming and media system 100 in more detail. Console 102 has a central processing unit (CPU) 200, and a memory controller 202 that facilitates processor access to various types of memory, including a flash Read Only Memory (ROM) 204, a Random Access Memory (RAM) 206, a hard disk drive 208, and portable media drive 106. In one implementation, CPU 200 includes a level 1 cache 210 and a level 2 cache 212, to temporarily store data and hence reduce the number of memory access cycles made to the hard drive 208, thereby improving processing speed and throughput.

CPU 200, memory controller 202, and various memory devices are interconnected via one or more buses (not shown). The details of the bus that is used in this implementation are not particularly relevant to understanding the subject matter of interest being discussed herein. However, it will be understood that such a bus might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, CPU 200, memory controller 202, ROM 204, and RAM 206 are integrated onto a common module 214. In this implementation, ROM 204 is configured as a flash ROM that is connected to memory controller 202 via a PCI bus and a ROM bus (neither of which are shown). RAM 206 is configured as multiple Double Data Rate Synchronous Dynamic RAM (DDR SDRAM) modules that are independently controlled by memory controller 202 via separate buses (not shown). Hard disk drive 208 and portable media drive 106 are shown connected to the memory controller 202 via the PCI bus and an AT Attachment (ATA) bus 216. However, in other implementations, dedicated data bus structures of different types can also be applied in the alternative.

A three-dimensional graphics processing unit 220 and a video encoder 222 form a video processing pipeline for high speed and high resolution (e.g., High Definition) graphics processing. Data are carried from graphics processing unit 220 to video encoder 222 via a digital video bus (not shown). An audio processing unit 224 and an audio codec (coder/decoder) 226 form a corresponding audio processing pipeline for multi-channel audio processing of various digital audio formats. Audio data are carried between audio processing unit 224 and audio codec 226 via a communication link (not shown). The video and audio processing pipelines output data to an A/V (audio/video) port 228 for transmission to a television or other display. In the illustrated implementation, video and audio processing components 220-228 are mounted on module 214.

FIG. 2 shows module 214 including a USB host controller 230 and a network interface 232. USB host controller 230 is shown in communication with CPU 200 and memory controller 202 via a bus (e.g., PCI bus) and serves as host for peripheral controllers 104(1)-104(4). Network interface 232 provides access to a network (e.g., Internet, home network, etc.) and may be any of a wide variety of various wire or wireless interface components including an Ethernet card, a modem, a wireless access card, a Bluetooth module, a cable modem, and the like.

In the implementation depicted in FIG. 2, console 102 includes a controller support subassembly 240 for supporting four controllers 104(1)-104(4). The controller support subassembly 240 includes any hardware and software components to support wired and wireless operation with an external control device, such as for example, a media and game controller. A front panel I/O subassembly 242 supports the multiple functionalities of power button 112, the eject button 114, as well as any LEDs (light emitting diodes) or other indicators exposed on the outer surface of console 102. Subassemblies 240 and 242 are in communication with module 214 via one or more cable assemblies 244. In other implementations, console 102 can include additional controller subassemblies. The illustrated implementation also shows an optical I/O interface 235 that is configured to send and receive signals that can be communicated to module 214.

MUs 140(1) and 140(2) are illustrated as being connectable to MU ports “A” 130(1) and “B” 130(2) respectively. Additional MUs (e.g., MUs 140(3)-140(6)) are illustrated as being connectable to controllers 104(1) and 104(3), i.e., two MUs for each controller. Controllers 104(2) and 104(4) can also be configured to receive MUs (not shown). Each MU 140 offers additional storage on which games, game parameters, and other data may be stored. In some implementations, the other data can include any of a digital game component, an executable gaming application, an instruction set for expanding a gaming application, and a media file. When inserted into console 102 or a controller, MU 140 can be accessed by memory controller 202.

A system power supply module 250 provides power to the components of gaming system 100. A fan 252 cools the circuitry within console 102.

An application 260 comprising machine instructions is stored on hard disk drive 208. When console 102 is powered on, various portions of application 260 are loaded into RAM 206, and/or caches 210 and 212, for execution on CPU 200, wherein application 260 is one such example. Various applications can be stored on hard disk drive 208 for execution on CPU 200.

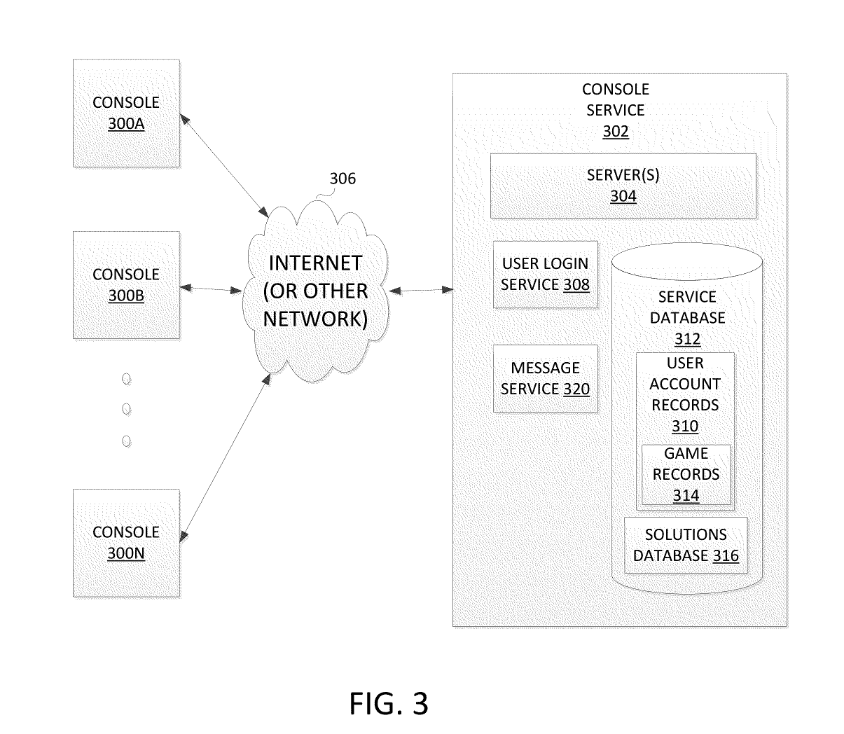

Gaming and media system 100 may be operated as a standalone system by simply connecting the system to monitor 150 (FIG. 1), a television, a video projector, or other display device. In this standalone mode, gaming and media system 100 enables one or more players to play games, or enjoy digital media, e.g., by watching movies, or listening to music. However, with the integration of broadband connectivity made available through network interface 232, gaming and media system 100 may further be operated as a participant in a larger network gaming community, as discussed below in connection with FIG. 3.

FIG. 3 provides a block diagram of multiple consoles 300A-300N networked with a console service 302 having one or more servers 304 through a network 306. In one embodiment, network 306 comprises the Internet, though other networks such as LAN or WAN are contemplated. Server(s) 304 include a communication component capable of receiving information from and transmitting information to consoles 300A-N and provide a collection of services that applications running on consoles 300A-N may invoke and utilize. As one example, server(s) 304 may serve a number of games to users. Some of those games may involve scenarios as discussed herein, where the users of consoles 300 are served a game, instances of which may or may not be successfully completed to a desired solution state depending on an initial state of data served as part of the game to the users. As part of the gaming applications, server(s) 304 may also be capable of generating, randomly or otherwise, initial states for a given scenario, and the software application(s) may also be able to check and/or validate user decisions against constraints and/or rules contained in a gaming application to generate intermediate data states. Alternatively or additionally, server(s) 304 may, through software application(s), draw known initial or intermediate states, along with solvability data, from solutions database 316, explained hereinafter. Server(s) 304 may be able to communicate initial or intermediate states, however obtained, along with some or all known solvability data, to user(s) via network 306 and then consoles 300A-N.

Consoles 300A-N may invoke user login service 308, which is used to authenticate a user on consoles 300A-N. During login, login service 308 obtains a gamer tag (a unique identifier associated with the user) and a password from the user as well as a console identifier that identifies the console that the user is using and a network path to the console. The gamer tag and password are authenticated by comparing them to user records 310 in a database 312, which may be located on the same server as user login service 308 or may be distributed on a different server or a collection of different servers. Once authenticated, user login service 308 stores the console identifier and the network path in user records 310 so that messages and information may be sent to the console. The login service 308 is not critical to the present technology and may be omitted in further embodiments.

User records 310 can include additional information about the user such as game records 314. Game records 314 include information for a user identified by a gamer tag and can include statistics for a particular game, progress made by player for a particular game and/or other game specific information as desired. As explained hereinafter, in one example, initial and intermediate data states for a game in progress by a particular user may be stored in game records 314 in association with that user.

User records 310 also include additional information about the user including games that have been downloaded by the user and licensing packages that have been issued for those downloaded games, including the permissions associated with each licensing package. Portions of user records 310 can be stored on an individual console, in database 312 or on both. If an individual console retains part or all of game records 314 and/or part or all of solutions database 316, this information can be provided to console service 302 through network 306. Additionally, the console has the ability to display information associated with part or all of game records 314 and/or part or all of solutions database 316 without having a connection to console service 302.

Solutions database 316 may include solvability data for the games and other scenarios in embodiments of the present technology. The term “solvability data” as used herein can broadly refer to data pertaining to a game or other scenario. In one example, solvability data includes known-solvable data states for scenarios that have successfully been completed by users of consoles 300. These known-solvable data states may include known initial or intermediate states of data of a game or other scenario. In further examples, solvability data may include whether or not a certain initial or intermediate state of the game may be solvable, and under what conditions a certain initial or intermediate state of the game may or may not be solvable. It is conceivable that the solutions database 316 will be able to communicate with game records 314, obtaining data contained therein to create or modify solvability data.

Server(s) 304 also include message service 320 which permits one console, such as console 300A, to send a message to another console, such as console 300B. Such messages can include text messages, voice messages, and specialized in-game text messages known as invites, in which a user playing the game on one console invites a user on another console to play in the same game while using network 306 to pass gaming data between the two consoles so that the two users are playing from the same session of the game. Solvability data and initial or intermediate data states pertaining to one more games may also be shared among consoles 300A-N using message service 320. Message service 320 may be omitted in further embodiments of the present technology.

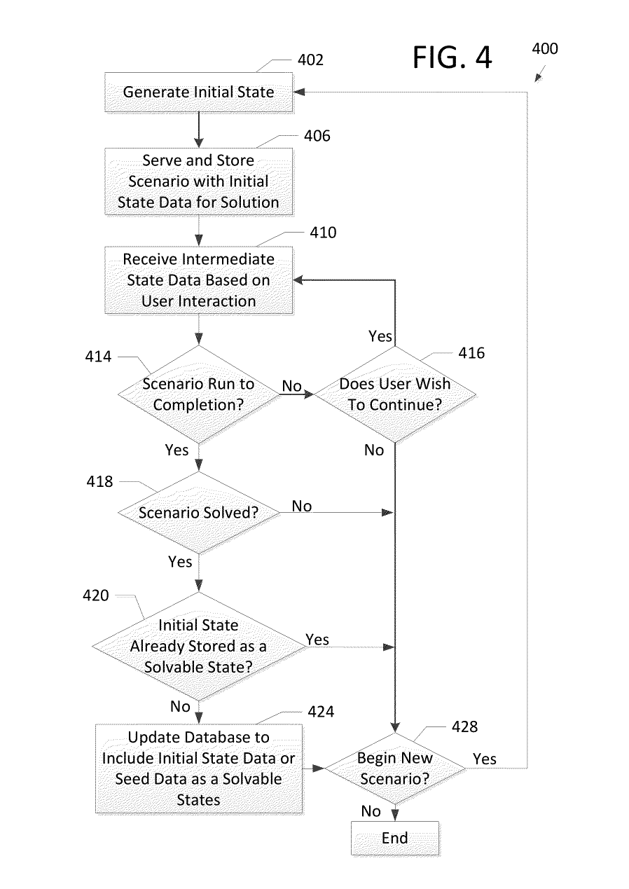

Embodiments of the present technology for identifying initial data states having a solvable outcome using crowdsourcing will now be described with reference to the exemplary method 400 of FIG. 4. In one embodiment, a user begins a game such as Klondike Solitaire by employing user login service 308, and, having been authenticated by console service 302, runs a program on console(s) 300A-N which presents the user with a scenario to be solved. The system, possibly server(s) 304, generates an initial data state for the game, puzzle, or other scenario in step 402. The system may employ a random number generator to generate inputs which may in turn be used as seed inputs for the initial state. Alternatively, an initial state might be created by following a programmed heuristic to generate a new state from some stored state. Other embodiments might work differently.

In step 406, the system may store the initial state in game records 314 and may also serve initial state data to user via network 306 and console(s) 300A-N to begin the scenario. Additionally, some embodiments of the present technology may have steps 406 and 410 performed by console(s) 300, thus interacting with console service 302 for the purpose of receiving initial states and reporting scenario completion.

The scenario proceeds by the user providing state transition decisions to console service 302 via network 306 in step 410, server(s) 304 being equipped with software that actively regulates state transition decisions according to the rules and constraints of the scenario. In step 414, the system may determine whether the intermediate states obtained via user decisions are in fact end states (as known by service database 312). Used herein, “end state” may refer to a state at which the scenario has run to completion and no further moves or user interactions in the scenario are possible (or useful).

If the scenario has not reached the end state, the system may check in step 416 whether a user wishes to continue or terminate an uncompleted scenario. If the user wishes to terminate the scenario, the system may transition to step 428 to check whether the user wishes to begin a new scenario as explained below. If the user does not wish to terminate the scenario in step 416, the flow returns to step 410 to receive further intermediate data states.

If step 414 indicates that the scenario has reached an end state, the system may determine in step 418 whether or not the end state constitutes the desired solution state. If not the desired solution state, the user may be asked whether they wish to begin a new scenario in step 428. On the other hand, if the user has successfully completed the desired solution state in step 418, the initial data state for the solved scenario may be stored in solutions data base 316. However, in order to avoid storing duplicate initial data states for solved scenarios, server(s) 304 may inquire of solutions database 316 whether or not the initial state already exists in game records 314. If so, the system moves to step 428. If not, the server(s) 304 stores the initial state data, or the seed data uniquely generating the initial state, in solutions database 316.

The system then transitions to step 428, where the user is asked whether they wish to begin a new scenario. If not, process 400 terminates. If so, process 400 restarts at step 402.

It should be noted that process 400 is not limited to any fixed number of users, consoles 300A-N, or console service systems 302. In fact, process 400 may be most useful when engaging many participants to generate large volumes of data about solvable states for scenarios.

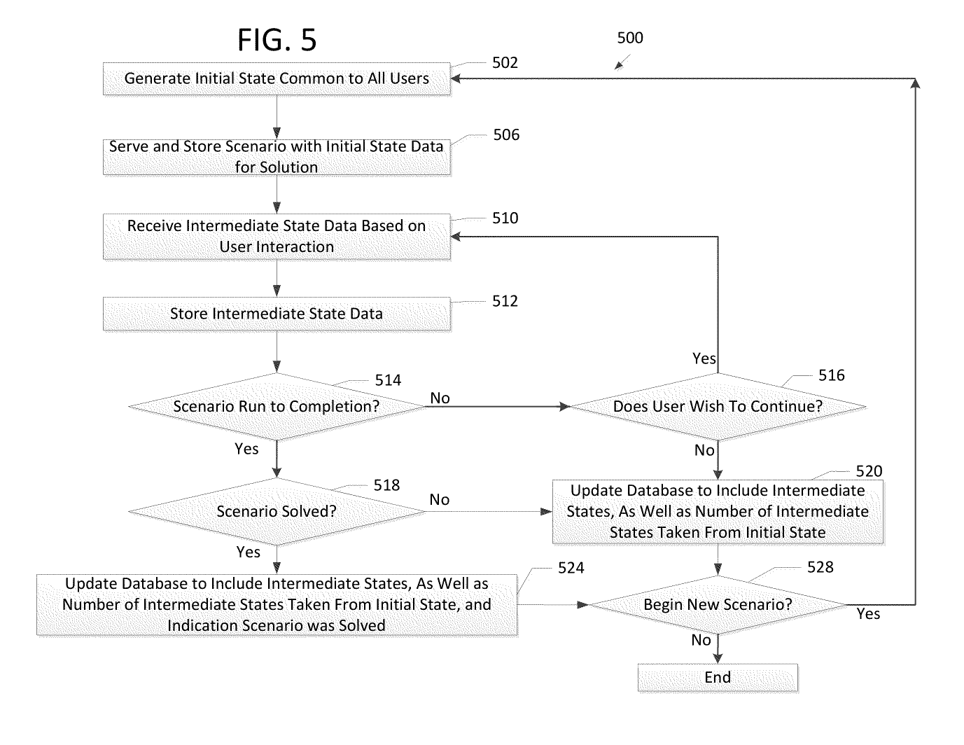

FIG. 5 depicts an alternate example 500 of the present technology. Example 500 might be employed for many possible reasons, one of which may be the generation of a large number of possible solution paths for a common initial state of a scenario. In step 502, the process may begin by server(s) 304, perhaps using some sort of state-generating software engine, generating a common initial state for one or more users engaged by the system. Following step 502 is step 506, in which the initial state data may be stored in the game records 314 and transmitted to the user(s) through network 306, console(s) 300, and display(s) 150.

After step 506, as the user(s) may attempt to solve the scenario from the initial state presented by step 506, data pertaining to intermediate states of the scenario reached by user interaction may be collected by server(s) 304 in step 510 and stored in game records 314 in step 512. In this and other embodiments, the data collected and stored may be capable of uniquely identifying the current state of the scenario. It may also include the number of moves taken thus far by a given user.

In step 514, server(s) 304 may determine whether the scenario has run to completion (or no other meaningful moves are possible). For example, an end state of the data may match a known end state stored in service database 312. Alternatively, the system may identify that no further user-interactions are possible. It may happen that further user-interactions are possible, but will not serve to advance the scenario beyond its current state. As one example in Klondike solitaire, a user may not be able to add move any cards around between the existing columns of descending-ordered cards, or add any cards onto the columns from the deck. In this event, the system may recognize this as the scenario having run to completion, even though the user may still cycle through the deck endlessly without advancing the game further. One a scenario is determined to have run to completion, the system transitions to step 518. Otherwise, the system transitions to step 516. In step 516, the system asks the user whether or not to continue the scenario. If the user wishes to continue, the system resumes the scenario at step 510. Otherwise, the system transitions to step 520.

If the scenario was not successfully completed to the solution state in step 518, the system may store information including but not limited to the current data state of the scenario to solutions database 316 in step 520. Indeed, embodiments may also store intermediate states taken by the user from the initial state to the current state. Further embodiments may include as stored data statistics pertaining to user performance in the scenario, such as the number of state transitions to the current state, the minimum number of state transitions taken between the initial state and the current state across all users, as well as the maximum, mean, median, and variance of that quantity. As with other data mentioned herein, embodiments of the present technology may store this data elsewhere in service database 312 or some other database.

If the scenario was successfully completed to the solution state in step 518, the system transitions to step 524, in which it may store information including the intermediate states reached by the user between the initial state and the desired solution state. Furthermore, the system may designate the stored states as solvable for reference in future attempts at solving the scenario. In addition to the data states themselves, the system may also use solutions database 316 to store more data about the solution, including statistics pertaining to user performance in the scenario. These statistics may include data such as the number of state transitions to the solution state, the minimum number of state transitions taken between the initial state and the solution state across all users, as well as the maximum, mean, median, and variance of that quantity. From step 524, the system transitions to step 528.

In step 528, server(s) 304 asks the user (through network 306, console(s) 300, and display 150) whether or not he or she wishes to try another scenario. If the user does wish to try another scenario, the scenario restarts at step 502. Otherwise, the scenario terminates.

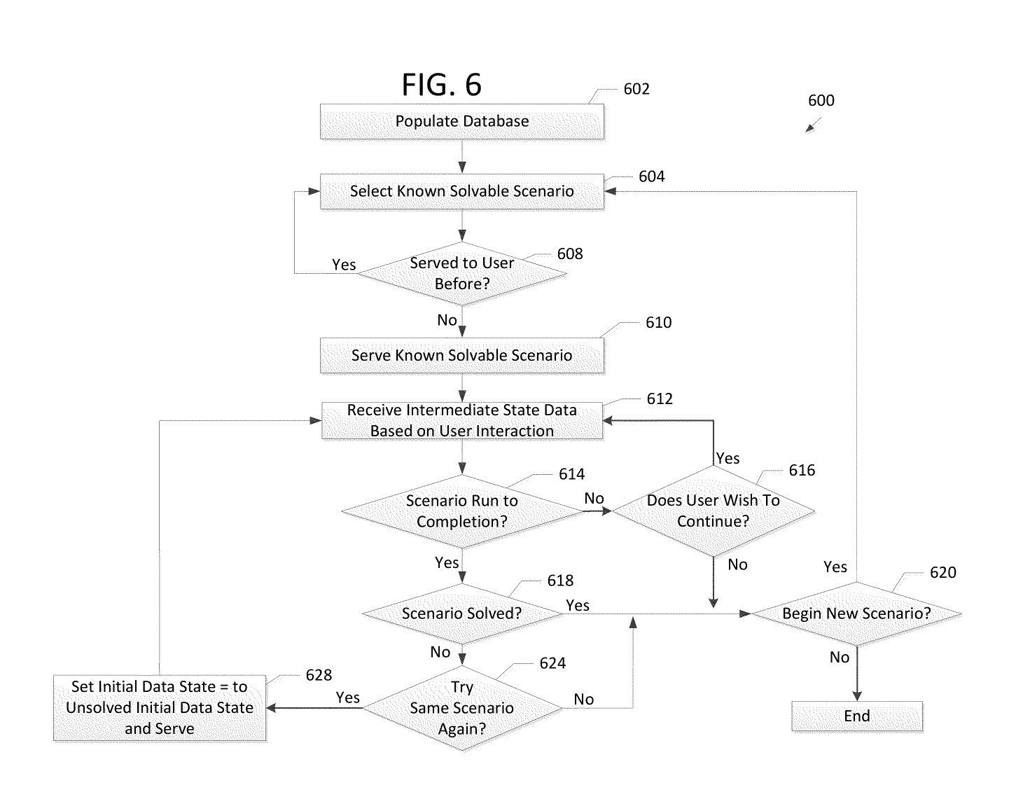

FIGS. 4 and 5 set forth examples for building solutions database 316 with data such as known-solvable initial data states, known-solvable intermediate data states, and other statistics regarding solved and/or unsolved scenarios. FIGS. 6-8 set forth some applications of solutions database once it includes at least some of the above-described data.

FIG. 6 represents an exemplary method 600 which may find use in challenging users to solve a scenario from known-solvable data states. In step 602, solutions database 316 may be populated with any number of known-solvable states and/or other information. This can be accomplished for example as described above with respect to FIGS. 4 and 5.

In step 604, the system may draw from solutions database 316 a known-solvable state. Then, in step 608 check, the system may check with user account records 310 whether or not the selected state has been presented to the user before. If it has, in embodiments, the system may return to step 304 and the loop continues until a state that is new for the user is found. If the state is new for the user, the system passes the state to the user in step 610. In other embodiments, step 608 may be omitted, and the user may indeed receive and attempt the same state more than once.

After step 610, the user may interact with the system by attempting to solve the scenario given the known-solvable state provided by step 610. In step 612, the server receives data pertaining to states reached by the user attempts. The system may then determine whether or not the scenario is completed in step 614. If the reached state is not an end state, the system reaches step 616. If it is determined that the scenario has run to the end state, the system reaches step 618 instead.

In step 616, the user may decide whether or not to continue attempting to solve the presented scenario. If the user decides to continue, the system returns to step 612. Otherwise, the system reaches step 620.

In step 618, the system may determine whether or not the end state reached by the user attempt at the scenario is the desired solution state. If it is, the system moves to step 620. Alternative embodiments of the present technology may add a step that updates solutions database 316 with data about intermediate states reached by the user in the path to the solution. Such a step may contribute to the system's knowledge of known-solvable states. If the state reached by the user is not the desired solution state, the system moves to step 624.

In step 620, the system may ask the user whether or not to begin a new scenario with new initial state data. If the user agrees, a new scenario is presented at step 604. Otherwise, the scenario terminates.

On the other hand, if the scenario was not successfully completed to the desired solution state in step 618, in step 624, the system may ask the user whether or not to try solving the scenario from the same known solvable-state presented in step 610. If the user agrees, then the system moves to step 628, in which the state of the scenario may be reset to the same state presented in step 610. From there, the user may resume the attempt of solving the scenario at step 612 of the process. If the user does not agree, the system moves to step 620 and proceeds as described above.

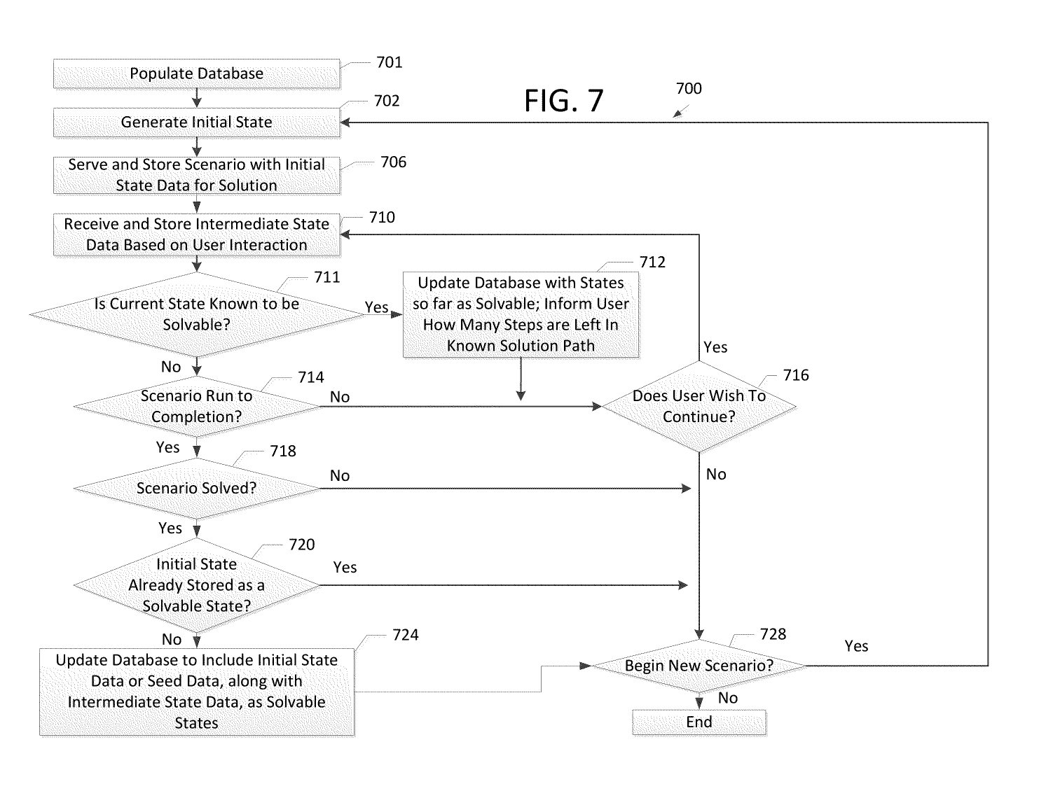

In the embodiment of FIG. 6, the users are served a known-solvable initial state. However, in further embodiments of the present technology, the user may be served an initial state which may or may not be solvable, but at some point during attempt at solution of the scenario, the user reaches an intermediate state known to be solvable. To this end, FIG. 7 represents another exemplary method 700 of the present technology. Uses of this exemplary method may possibly include discovering new solvable initial states by checking whether from these initial states, users can reach known solvable intermediate states. In step 701, solutions database 316 may be populated with any number of known solvable states of a given scenario, using methods possibly but not necessarily like those described for step 602 of method 600. The system may then proceed to generate (step 702) and serve (step 704) random initial states of the scenario, much as in steps 402 and 406, respectively, of method 400.

In step 710, the user may interact with the system to move between intermediate states of the scenario. These intermediate states may then be received by server(s) 304 and stored by game records 314.

In step 711, the system may check the received state against known-solvable states populating solutions database 316, such as those stored in step 701. If a match is found, the system proceeds to step 712, where the system may move the states stored thus far in game records 314 into solutions database 316, marking them as solvable. Optionally, the system may also inform the user that they have reached a state known to be solvable from that point, and may optionally further inform the user as to the smallest known number of steps from the current known-solvable state to the actual desired solution state. Further embodiments of the present technology may enable the user to learn more statistical information about known solutions from the current state.

In step 716, the system may ask the user whether or not to continue the current scenario. If the user wishes to continue, the scenario resumes at step 710. Otherwise, the system may move to step 728.

If a current intermediate step is not known to be solvable in step 711, the system proceeds to step 714, where it may be determined whether the intermediate state obtained via user decisions is in fact an end state. If the obtained state does not constitute an end state, the system transitions to step 716. Otherwise, the system transitions to step 718.

In step 718, server(s) 304 may compare the state passed from step 714 against a known solution state stored in service database 312. If the state thus received is not the desired solution state, the system may notify users that the scenario was not successfully solved, and may prompt a user whether they would like to begin a new game or scenario in step 728.

If the end state is the desired solution state in state 718, then in step 720, server(s) 304 may inquire of solutions database 316 whether or not the initial state and the intermediate states in game records 314 have been identified and stored prior to the current attempt. If so, the system moves to step 728. If not, the server(s) 304 may store the initial state data, or the seed data uniquely generating the initial state, in solutions database 316. Also, the system may store any data uniquely identifying previously unsolved intermediate states in solutions database 316. Further embodiments of the present technology may also store information regarding the order of intermediate states taken to reach the desired solution state from the initial state. The system may then transition to step 728.

In step 728, the system asks the user whether or not to begin a new scenario. If not, process 700 terminates. If so, process 700 restarts at step 702.

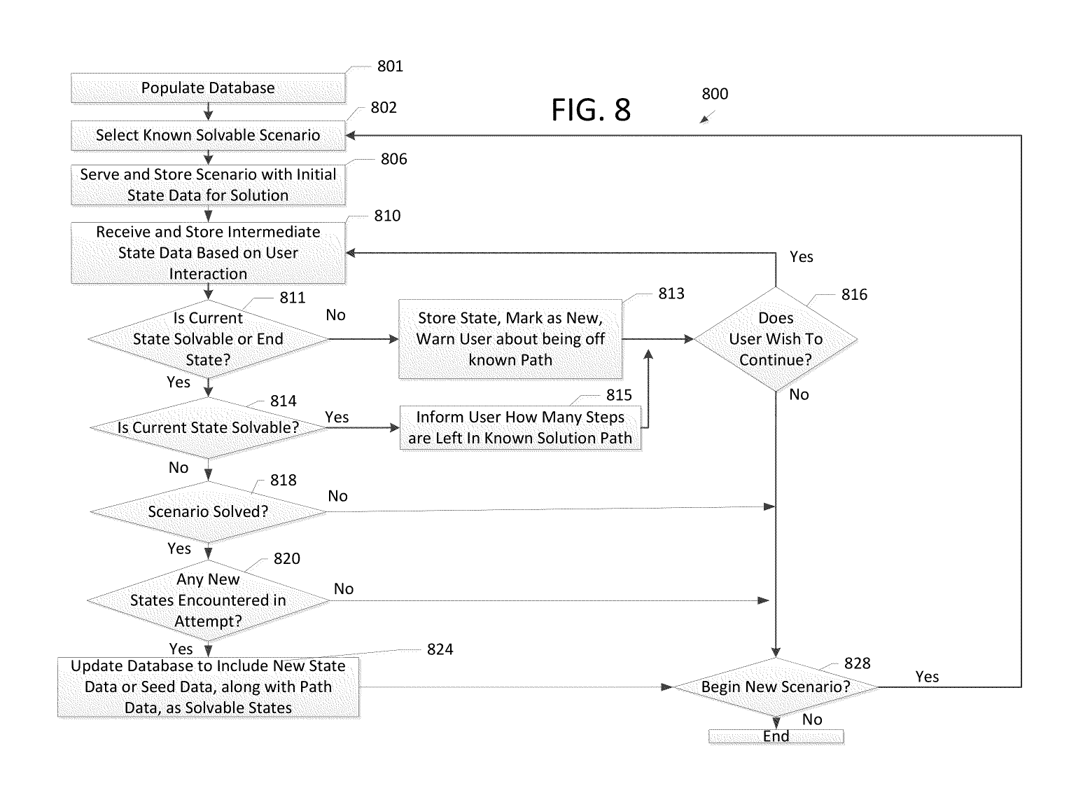

Embodiments such as described with respect to FIGS. 6 and 7 make use of the solutions database 316 which may be built using crowdsourcing as described for example with respect to FIGS. 4 and 5. However, in the embodiments of FIGS. 6 and 7 where the solutions data base is used, the solutions data base may continue to be augmented when new known-solution states are identified. Hence, another exemplary implementation of the present technology is process 800 as shown in FIG. 8. One potential application of method 800, out of many, may be to challenge users to quickly complete scenarios with known solution paths, and, along the way, possibly collect data about new solution paths. In step 801, the solutions database 316 may be populated with known-solvable scenarios, either by using the results of previous user attempts, using computational means, using some combination thereof, or using some other method.

Upon engagement by the user, server(s) 304 may, in step 802, draw from solutions database 316 a known-solvable state of a given scenario. In step 806, the server may then present the state for the user to solve, as well as store data identifying the state to game records 314 in order to initiate and track the user's attempt to solve the scenario.

In step 810, the server may receive data pertaining to intermediate states reached by the user. It may then store this data in game records 314.

In step 811, the system may check whether the state most recently reached by the user in step 810 is either known to be solvable or an end state as defined above. If neither of those is the case, the system transitions to step 813. If either of those possibilities is true, the system transitions to step 814.

In step 813, the scenario has not been completed, yet the current state is not known to be solvable. Thus, the system may store the state in game records 314, mark it as a potentially new solvable state, and warn the user that he or she has strayed from a known solution path. Upon doing so, the system transitions to step 816.

In step 814, the current state is either a known solvable state or an end state. If the current state is an end state, the system transitions to step 818. Otherwise, the system transitions to step 815.

In step 815, the current state is known to be a solvable state. The system may thus determine the smallest number of steps known by which the user may reach the desired solution state. To compute this number, the system may use a counting function on the least known number of interactions from the solution state, data from solutions database 316, or some other means. The system may then communicate this value to the user. In further embodiments of the present technology, the user may have access to various statistics with respect to known solvable data states of the scenario. These may include success rates of solution for previous users who have encountered a given state, or perhaps the largest known number of steps taken from the current state to solution. Upon computing this data, the system relays it to the user and transitions to step 816.

In step 816, the system may ask the user whether or not to continue the scenario. If the user agrees to continue, the system returns to step 810. Otherwise, the system moves on to step 828.

If the scenario has run to completion in step 814, the system may decide in step 818 whether the user has reached the desired solution state. If so, the system transitions to step 820. Otherwise, the system transitions to step 828, and in further embodiments the system may employ service database 312 to store information indicating that some or all states reached by the current attempt can lead to end states.

In step 820, the user has reached the desired solution state of the scenario and the scenario is considered solved. The system may then check whether the user reached any states previously unknown to be solvable in the course of solving the scenario, such as those marked by step 813. The system may possibly accomplish this by checking if any such states stored in game records 314 are already stored in solutions database 316. If there are any such new states, the system transitions to step 824. If not, the system transitions to step 828.

In step 824, one or more states reached by the user in the course of solving the scenario were not known to be solvable by the system prior to or during the current attempt. The system may thus add these states, or data uniquely identifying these states, into solutions database 316, thus updating their status as known-solvable states. Embodiments of the present technology may also include data about the path that was taken by the user from the state provided by step 806 to the desired solution state. Upon doing so, the system moves to step 828.

In step 828, the system may ask the user whether or not to attempt the scenario again. If the user indicates a wish to try again, the system returns to step 802. Otherwise, the scenario terminates.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

We claim:

1. A method of identifying a subset of one or more initial data states which are solvable to reach a desired solution state in a scenario to be solved, the method comprising:
(a) serving a group of initial data states to a group of users, the group of initial data states including the subset of one or more initial data states which are solvable;
(b) determining one or more instances of the scenario being solved to the desired solution state by one or more users; and
(c) storing information to identify the subset of one or more initial data states from which the scenario was solved by the one or more users in said step (b).

2. The method of claim 1, wherein said step (c) of storing information to identify the subset of one or more initial data states comprises the step (d) of storing the subset of one or more initial data states.

3. The method of claim 1, wherein said step (c) of storing information to identify the subset of one or more initial data states comprises the step (e) of storing data from which the subset of one or more initial data states may be derived.

4. The method of claim 3, wherein said step (e) of storing data from which the subset of one or more initial data states may be derived comprises the step (f) of storing seed data used in deriving the subset of one or more initial data states.

5. The method of claim 1, further comprising the step (g) of randomly generating the group of initial data states in said step (a).

6. The method of claim 1, further comprising the step (h) of procedurally generating the group of initial data states in said step (a).

7. The method of claim 1, wherein the scenario to be solved is a computerized card game, and the group of initial data states served to the group of users is the initial state of the cards displayed to the group of users.

8. The method of claim 7, wherein the scenario to be solved is a computerized solitaire game, and the group of initial data states served to the group of users is the initial state of the cards displayed to the group of users.

9. A method of identifying known-solvable data states from a larger group of data states, the known-solvable data states being those data states from which users may reach a desired solution state in a scenario having a set of constraints, the method comprising:
(a) serving initial data states from a server to a group of user consoles for users of the user consoles to solve the scenario from the initial data states;
(b) receiving indications of user-interaction with the initial data states, to generate intermediate data states, in attempts by the users to solve the scenario;
(c) determining one or more instances of the scenario being solved to the desired solution state by one or more users; and
(d) storing information to identify the known-solvable data states from which the scenario was solved by the one or more users in said step (c).

10. The method of claim 9, wherein a known-solvable data state is an initial data state served to a client computing system.

11. The method of claim 9, wherein a known-solvable data state is an intermediate data state generated by user-interaction with an initial data state.

12. The method of claim 9, wherein initial and intermediate data states from which the scenario was solved in said step (c) are stored.

13. The method of claim 9, wherein initial and intermediate data states for both solved and unsolved instances of the scenario are stored.

14. The method of claim 9, wherein the initial data states served in said step (a) are randomly generated and different for different users.

15. The method of claim 9, further comprising the step of storing a number of user interactions it takes to get from the known-solvable data state to the desired solution state.

16. The method of claim 9, wherein the initial data states served in said step (a) are the same for each of the users.

17. A computer-readable medium having computer-executable instructions for programming a processor to perform a method of identifying known-solvable initial data states from a larger group of initial data states, the initial data states being an initial order of cards displayed to a user in a computerized card game, and the known-solvable initial data states being initial orderings of cards from which users may successfully complete the card game to a desired solution state, the method comprising:
(a) generating the initial data states of cards;
(b) serving the initial data states from a server to a group of user consoles for users of the user consoles to play the card game from the initial data states;
(c) receiving indications of user-interaction with the initial data states, to generate intermediate data states as users play the card game;
(d) determining one or more instances where one or more users successfully complete the card game to the desired solution state; and
(e) storing information to identify the known-solvable initial data states from which the card game was successfully completed to the desired solution state in said step (d).

18. The computer-readable medium of claim 17, further comprising the step of checking whether information to identify a specific known-solvable initial data state exists in a database where the information is stored in said step (e), and not storing information relating to a duplicate known-solvable initial state that is already stored in the database.

19. The computer-readable medium of claim 17, wherein said step (a) of generating the initial data states of cards comprises the step of generating initial data states for a card game including solitaire and bridge, a puzzle game or chess.

20. The computer-readable medium of claim 17, further comprising the step of serving known-solvable initial data states to users after storing information identifying a number of known-solvable initial data states.
